(19) United States
(12) Patent Application Publication
(10) Pub. No.: US 2026/0316422 A1
(43) Pub. Date: Oct. 15, 2026

(54) VITREOUS CARBON COMPOSITIONS, MULTI-LAYER LAMINATES, AND 3-D PRINTED ARTICLES

(71) Applicant: Carbon Ceramics Company LLC, Chapel Hill, NC (US)

(72) Inventors: Richard Purcell LUDINGTON, Chapel Hill, NC (US); Luis Eduardo MARIN, Plattsburgh, NY (US); Steven John HULTQUIST, Chapel Hill, NC (US)

(21) Appl. No.: 19/444,134

(22) Filed: Jan. 8, 2026

Related U.S. Application Data
(63) Continuation of application No. 17/997,732, filed on May 1, 2021, now abandoned.
(60) Provisional application No. 63/019,155, filed on May 1, 2020.

(51) Int. Cl. B32B 9/00; B32B 7/12; B32B 37/12; B32B 38/00

(52) U.S. Cl. CPC B32B 9/007; B32B 7/12; B32B 37/1284; B32B 2037/1253; B32B 2038/0076; B32B 2250/03; B32B 2307/702; B32B 2313/04

(57) ABSTRACT

Micromorphologically crack-free vitreous carbon articles having a length and width each of which is at least 10 mm, and a thickness of at least 5 mm are described, as well as multilayer laminates of micromorphologically crack-free vitreous carbon, and corresponding methods and apparatus for manufacture of same. 3D printed vitreous carbon articles are also described, together with 3D printing apparatus and methods for producing same. Methods are also described for forming vitreous carbon containing vitreous carbon nanolattice articles therein as filler. The vitreous carbon compositions, articles, and laminates of the disclosure overcome the thickness limitations of conventional vitreous carbon manufacturing methods and the microcracking issues attendant previous efforts to produce vitreous carbon of substantial size and thickness.

### CROSS REFERENCE TO RELATED APPLICATIONS

This is a continuation under 35 USC §120 of U.S. Patent Application 17/997,732 filed Nov. 1, 2022 in the names of Richard Ludington, Luis Eduardo Marin, and Steven John Hultquist for VITREOUS CARBON COMPOSITIONS, MULTI-LAYER LAMINATES, AND 3-D PRINTED ARTICLES, which in turn is a United States national phase under 35 USC §371 of International Patent Application PCT/US2021/030375 filed May. 1, 2021 in the names of Richard Ludington, Luis Eduardo Marin, and Steven John Hultquist for VITREOUS CARBON COMPOSITIONS, MULTI-LAYER LAMINATES, AND 3-D PRINTED ARTICLES, which claims the benefit under 35 USC §119 of United States Provisional Patent Application 63/019,155 filed May. 1, 2020 in the names of Richard Ludington, Luis Eduardo Marin, and Steven John Hultquist for VITREOUS CARBON COMPOSITIONS, MULTI-LAYER LAMINATES, AND 3-D PRINTED ARTICLES. The disclosures of all such prior patent applications are hereby incorporated herein by reference in their respective entireties, for all purposes.

### FIELD

The present disclosure relates generally to vitreous carbon compositions, multi-layer laminates, and 3D printed articles, and methods for manufacturing and using same. In various specific aspects, the disclosure relates to micromorphologically crack-free multi-layer vitreous carbon laminates and methods of making same, e.g., vitreous carbon laminate articles having a length and width each of which is at least 10 mm, and a thickness of at least 5 mm, and preferably at least 7 mm. In other aspects, the disclosure relates to vitreous carbon 3D printed articles that are channelized in the printing process, and in still other aspects, the disclosure relates to vitreous carbon compositions containing three-dimensional nanolattice bodies dispersed therein.

### DESCRIPTION OF THE RELATED ART

Burton et al. U.S. Patent 5,182,166 describes a wear-resistant composite structure including vitreous carbon in a continuous phase, and convoluted strengthening fibers interspersed throughout the vitreous carbon in a discontinuous phase. In this patent, the inventors describe the tendency of fiber-laden vitreous carbon material to crack during formation, and they describe the use of convoluted fibers (e.g., in the form of a mesh or wool having a radius of curvature/diameter ratio which is in the range of about 5:1 to about 20:1, constituting from 5% to 75% by weight (5% to 30% by volume) of the final composite) as resolving such cracking problem, enabling the production of non-granular, monolithic vitreous carbon materials which are free from grain boundaries, with a size of at least 100 mm in each of its x, y, z dimensions.

The Burton et al. ‘166 patent describes time-temperature relationships in making the vitreous carbon material, as including approximately 100 hours of curing of the resin, with slow increase in temperature to 300°-400°, followed by polymerization, which based on the disclosed temperature time rise may require 60-600 hours, followed by annealing/stabilization for 10-24 hours.

Burton et al. U.S. Patent 6,506,482 describes reinforced vitreous carbon composites that are isotropic, homogeneous and essentially completely void-free, essentially free of foam and fume indicia, in a bulk composite form having dimensions greater than 25 millimeters in each of the x, y and z directions thereof. This patent also discloses a multilayer laminate material comprising at least one layer of a vitreous carbon composite including a metal fiber discontinuous phase in a continuous phase pyrolyzed poly(furfuryl alcohol) vitreous carbon. Such patent teaches to form the vitreous carbon composite by disposing in a mold cavity a metal fiber matrix defining a three-dimensional structure including void space therein, and compressing the three-dimensional structure in the mold, e.g., to laterally conform the structure to the wall structure of the mold cavity while retaining void space therein, partially polymerizing exterior to the mold cavity a continuous phase precursor material comprising (i) a poly(furfuryl alcohol) monomer and/or oligomer and (ii) a polymerization catalyst, to conduct an exothermic polymerization reaction generating a heat of polymerization. The partially polymerized precursor material, subsequent to removal of at least part of the heat of polymerization therefrom, is then introduced into the mold cavity; compressively consolidating the partially polymerized precursor material with the three-dimensional structure in the mold cavity under polymerization conditions to form a metal-reinforced polymer composite material; and subjecting the metal-reinforced polymer composite material to pyrolysis conditions effective to pyrolyze the polymer in the composite material, to yield the metal-reinforced vitreous carbon composite material. The pyrolysis conditions are stated to be set out in the Burton et al. ‘166 patent.

Whitmarsh U.S. Patent No. 7,862,897 describes a biphasic nanoporous vitreous carbon material with a cementitious morphology characterized by presence of non-round porosity, having superior hardness and tribological properties, as useful for high wear-force applications. The biphasic nanoporous vitreous carbon material is produced by firing, under inert atmosphere, of particulate vitrified carbon in a composition containing (i) a precursor resin that is curable and pyrolyzable to form vitreous carbon and, optionally, (ii) addition of one or more of the following: solid lubricant, such as graphite, boron nitride, or molybdenum disulfide; a heat-resistant fiber reinforcement, such as copper, bronze, iron alloy, graphite, alumina, silica, or silicon carbide; or one or more substances to improve electrical conductivity, such as dendritic copper powder, copper "felt" or graphite flake, to produce a superior vitreous carbon that is useful alone or as a continuous phase in reinforced composites, in relation to conventional glassy carbon materials.

The Whitmarsh ‘897 patent discloses the production of glassy carbon containing about 13.8% porosity. At column 9, line 21 to column 10, line 3 therein, Whitmarsh describes a method of making a vitreous carbon body of a predetermined size, in which a plurality of vitreous carbon precursor articles of smaller size than the predetermined size is formed, wherein each of such precursor articles is formed of a cured precursor resin and plurality of cured vitreous carbon precursor articles are bonded to one another, using a bonding medium including the precursor resin and catalyst, to form an aggregate body, and the aggregate body, including the cured bonding medium, then is pyrolyzed, to yield the vitreous carbon body of biphasic nanoporous vitreous carbon, of predetermined size. The bonding medium may contain particulate vitrified carbon dispersed in the precursor resin so that the changes in the bonding medium during pyrolysis match the changes during such pyrolysis that occur in the cured precursor articles used as constituents of the aggregate body.

Although the Burton et al. ‘166 and ‘482 patents describe large-scale (x, y, z) vitreous carbon products having thicknesses exceeding 25 mm or even 100 mm, Whitmarsh states at column 4, lines 27-34 that vitreous carbon has excellent tribological properties but pure vitreous carbon is limited to a maximum thickness of approximately 0.2 in., a limitation that can be overcome by incorporating a copper fiber matrix into a vitreous carbon matrix, but results in vitreous carbon that exhibits an unsuitable level of cracks in the final product. Whitmarsh correspondingly presents the biphasic material of the ‘897 patent as a solution to such thickness limitation, but the porosity of this biphasic material is significant and microcracks are found to be present in its micromorphology, with consequent adverse effect on the strength and structural integrity of the material.

Whitmarsh U.S. Patent 8,052,903 describes a defect-free vitreous carbon material having a three-dimensional (x,y,z) size in which each of the x, y and z dimensions exceeds twelve millimeters. A process of making such vitreous carbon material employs a three-dimensional fiber mesh that vaporizes at elevated temperature, in which the mesh is impregnated with a polymerizable resin and thereafter the resin is cured. During the initial stage(s) of pyrolysis, the mesh volatilizes to yield a residual network of passages in the cured resin body that thereafter allows gases to escape during pyrolysis of the cured resin material to form the vitreous carbon product. As a result, it is stated to be possible to form defect-free vitreous carbon material of large size, suitable for use in structural composites, and product articles such as sealing members, brake linings, electric motor brushes, and bearing members.

The Whitmarsh ‘903 patent at column 1, lines 12-27 states that all currently known methods for manufacturing vitreous carbon are severely limited in the size of defect-free vitreous carbon material they produce, and that although length and width dimensions can be virtually any size, but thickness is effectively limited to no more than about 10 mm for defect-free pure vitreous carbon material, with thicknesses above such value producing material that is cracked, pitted, chipped (spalled) or otherwise has morphological defects that render it unsuitable for commercial use.

At column 1, lines 47-50, the Whitmarsh ‘903 patent, in addressing the various problems associated with the Burton et al. patent approaches, points out that “metal reinforcement elements during the long pyrolytic vitrification process can form metal carbides that are brittle and substantially impair the strength and structural integrity of the composite.” The Whitmarsh ‘903 patent technique of using a pyrolytically evanescent mesh to create a network of tubular voids to allow escape of gas during the pyrolysis operation, however, increases the void volume and porosity of the vitreous carbon material, and like the ‘897 patent methodology, produces a vitreous carbon product in which voids adversely affect the strength and structural integrity of the material.

In addition, the presence of voids in the vitreous carbon is associated with microcracks in the micromorphology of the vitreous carbon, which can thereafter propagate in the vitreous carbon material in use, and adversely affect the structural integrity and performance of such material.

Further, all of the methods in the aforementioned patents entail excessively long processing times to produce vitreous carbon articles, potentially as long as 700 hours (Burton et al. U.S. Patent 5,182,166), thereby rendering the approaches of manufacturing the vitreous carbon unsuitable for high-volume commercial manufacturing. Attempts to substantially shorten the processing times have resulted in failures.

All of the vitreous carbon products of the methods described in the aforementioned patents suffer from microcracks. Accordingly, the “thickness problem” associated with vitreous carbon has not been solved by the approaches set forth in the above-discussed patents, and at the current time, no commercially available microcrack-free vitreous carbon material is available at thickness greater than 4 mm.

In consequence, the art continues to seek improvements that address and overcome the thickness problem, and that enable the commercial-scale production of microcrack-free vitreous carbon materials at thicknesses greater than 5 mm, and preferably at least 7 mm.

### SUMMARY

The present disclosure relates to vitreous carbon compositions, laminates, and articles and methods for making and using the same.

In one aspect, the disclosure relates to a micromorphologically crack-free vitreous carbon article having a length and width each of which is at least 10 mm, and a thickness of at least 5 mm, preferably a thickness of at least 7 mm, and most preferably a thickness of at least 10 mm.

In another aspect, the disclosure relates to a micromorphologically crack-free multilayer laminate vitreous carbon article, comprising at least three vitreous carbon layers, wherein such article has a length and width each of which is at least 10 mm, and a thickness of at least 5 mm, preferably a thickness of at least 7 mm, and most preferably a thickness of at least 10 mm.

In a further aspect, the disclosure relates to a multilayer laminate vitreous carbon article, comprising at least two micromorphologically crack-free sheets of vitreous carbon, each of the sheets having a length and width each of which is at least 10 mm, and a thickness not exceeding 4 mm, and a bonding layer of catalyzed furfuryl alcohol between adjacent pair(s) of the micromorphologically crack-free sheets of vitreous carbon.

A further aspect of the disclosure relates to a multilayer laminate vitreous carbon article, comprising at least two micromorphologically crack-free sheets of vitreous carbon, each of the sheets having a length and width each of which is at least 10 mm, and a thickness not exceeding 6 mm, and a bonding layer of catalyzed furfuryl alcohol between adjacent pair(s) of the micromorphologically crack-free sheets of vitreous carbon.

A still further aspect of the disclosure relates to a method of forming a micromorphologically crack-free vitreous carbon article having a length and width each of which is at least 10 mm, and a thickness of at least 5 mm, preferably a thickness of at least 7 mm, and most preferably a thickness of at least 10 mm, such method comprising: providing first and second sheets of micromorphologically crack-free vitreous carbon, wherein each of the first and second sheets has (i) a length and width each of which is at least 10 mm, and (ii) a thickness that does not exceed 4 mm, but wherein the combined thickness of the first and second sheets is at least 5 mm; applying a curable and pyrolyzable resin to a face of the first sheet to produce a resin-bearing face; mating the resin-bearing face of the first sheet in contact with a face of the second sheet so that the first and second sheets are consolidated with a layer of the resin therebetween; curing the resin between the first and second sheets to form a cured resin layer therebetween; and pyrolyzing the cured resin layer to form the micromorphologically crack-free vitreous carbon article having a length and width each of which is at least 10 mm, and a thickness of at least 5 mm, preferably a thickness of at least 7 mm, and most preferably a thickness of at least 10 mm.

Another aspect of the disclosure relates to an apparatus for forming a micromorphologically crack-free vitreous carbon article having a length and width each of which is at least 10 mm, and a thickness of at least 5 mm, preferably a thickness of at least 7 mm, and most preferably a thickness of at least 10 mm, from (a) first and second sheets of micromorphologically crack-free vitreous carbon, wherein each of the first and second sheets has (i) a length and width each of which is at least 10 mm, and (ii) a thickness that does not exceed 4 mm, but wherein the combined thickness of the first and second sheets is at least 5 mm, with the first and second sheets in mated contact with one another with a curable and pyrolyzable resin layer therebetween, as a stacked body, or (b) a laminate stack formed from the stacked body by curing and pyrolysis of the curable and pyrolyzable resin layer thereof, and addition of one or more sheets of micromorphologically crack-free vitreous carbon and/or one or more additional laminates of micromorphologically crack-free vitreous carbon, with a resin layer of the curable and pyrolyzable resin underlying each added sheet and/or added laminate, such apparatus comprising: a reactor vessel enclosing an interior volume in which the stacked body or laminate stack is disposed; a hydraulic press drive assembly arranged to apply mechanical pressure to the stacked body or laminate stack on outer faces thereof; and a heating assembly arranged to subject the stacked body or laminate stack to elevated temperature for curing and pyrolysis of the curable and pyrolyzable resin layer or layers therein.

Yet another aspect of the disclosure relates to a 3D printing apparatus for 3D printing of vitreous carbon articles, comprising a first reservoir containing a curable and pyrolyzable resin; a first print head arranged in resin-receiving relationship to the first reservoir; a 3D printer platform for printing of the resin thereon; a controller arranged to translate the first print head for printing of the resin on the 3D printer platform; and a heating assembly arranged to subject the printed resin to elevated temperature for curing and pyrolysis thereof to form 3D printed vitreous carbon articles.

A further aspect of the disclosure relates to a 3D printed vitreous carbon article that is channelized with 3D print-defined channels, and to a method of making same.

A still further aspect of the disclosure relates to a composition comprising a cured precursor of vitreous carbon, or a pyrolyzate thereof, containing a nanolattice vitreous carbon filler therein.

Yet another aspect of the disclosure relates to a method of making a composition comprising a cured precursor of vitreous carbon, or a pyrolyzate thereof, containing a nanolattice vitreous carbon filler therein.

Other aspects, features and embodiments of the disclosure will be more fully apparent from the ensuing description and appended claims.

### BRIEF DESCRIPTION OF THE DRAWINGS

FIG. 1 is a schematic representation of a three-layer assembly, including two sheets of micromorphologically crack-free vitreous carbon with a layer of catalyzed resin film on the top face of the lower vitreous carbon sheet, prior to mating engagement of the vitreous carbon sheets with one another with the layer of catalyzed resin film therebetween.

FIG. 2 is a schematic representation of the three-layer assembly of FIG. 1, after mating engagement of the vitreous carbon sheets with one another with the layer of catalyzed resin film therebetween.

FIG. 3 is a schematic representation of a six-layer composite assembly of two three-layer assemblies, each as shown in FIG. 2, with a layer of catalyzed resin film on the top face of the lower vitreous carbon three-layer assembly, prior to mating engagement of the vitreous carbon three-layer assemblies with one another with the layer of catalyzed resin film therebetween.

FIG. 4 is a schematic representation of an apparatus for forming vitreous carbon laminates of the present disclosure, according to another embodiment thereof.

FIG. 5 is a schematic representation of an apparatus for 3D printing of vitreous carbon articles, in accordance with a further aspect of the invention.

FIG. 6 is a schematic representation of an apparatus for 3D printing of vitreous carbon articles, in accordance with another aspect of the invention.

FIG. 7 is a top plan view of a channelized vitreous carbon bearing article formed by 3D printing, in accordance with an additional aspect of the disclosure.

FIG. 8 is a schematic perspective view of a vitreous carbon compressor shaft seal ring according to a further embodiment of the disclosure.

FIG. 9 is a schematic depiction of a nanolattice filler article, and steps involved in forming a vitreous carbon composition according to a further aspect of the invention.

### DETAILED DESCRIPTION

The present disclosure relates generally to vitreous carbon compositions, multi-layer laminates, and 3D printed articles, and methods for manufacturing and using same. In various specific aspects, the disclosure relates to micromorphologically crack-free multi-layer vitreous carbon laminates and methods of making same, e.g., vitreous carbon laminate articles having a length and width each of which is at least 10 mm, and a thickness of at least 5 mm, preferably a thickness of at least 7 mm, and most preferably a thickness of at least 10 mm. In other aspects, the disclosure relates to vitreous carbon 3D printed articles that are channelized in the printing process, and in still other aspects, the disclosure relates to vitreous carbon precursor or pyrolyzate compositions containing three-dimensional vitreous carbon nanolattice bodies dispersed therein.

The disclosure in various aspects reflects the discovery that by utilizing sheets of microcrack-free vitreous carbon material wherein each sheet has thickness not exceeding 4 mm (or in other embodiments not exceeding 6 mm) and a length and width of at least 10 mm, a film of catalyzed resin, e.g., furfuryl alcohol catalyzed with suitable catalyst, may be employed as a bonding medium, to form resulting multilayer laminates that are processable by curing and subsequent pyrolysis operations to produce micromorphologically crack-free multilayer laminate vitreous carbon articles having a thickness of at least 5 mm, preferably at least 7 mm, and most preferably at least 10 mm.

The thickness of such microcrack-free vitreous carbon material and articles in the practice of the present disclosure may be of any suitable thickness attainable by the fabrication methods and techniques herein disclosed, and in specific embodiments may be at least 5, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 200, 300, 400, 500, 600, 700, 800, 900, 1000 or more millimeters in thickness. In various embodiments, the thickness of such vitreous carbon material and articles may be in a range defined by any of the foregoing specific numeric values as endpoints of the range, wherein the lower end point is numerically less than the upper end point of such range.

As used herein, the term “micromorphologically crack-free” refers to vitreous carbon material in which any voids or defects are below 100 µm in size or characteristic dimension. Preferably, the micromorphologically crack-free vitreous carbon is a material in which any such voids or defects are below 50 µm, 40 µm, 30 µm, 25 µm, 20 µm, 15 µm, 10 µm, 5 µm, 1 µm, 500 nm, 200 nm, 100 nm in size or characteristic dimension, or below other maximum size or characteristic dimension, or in a range defined by any of the foregoing specific numeric values as endpoints of the range, wherein the lower end point is numerically less than the upper end point of such range.

Although Whitmarsh U.S. Patent No. 7,862,897 has proposed using catalyzed resin as a glue for binding vitreous carbon articles, the articles taught by Whitmarsh in such patent are pieces or particles that are used to produce a biphasic material in a cementitious morphology with non-round porosity, as discussed in the Background section hereof. A priori, such approach does not implicate or suggest the use of sheets being consolidated into a laminated structure. The Whitmarsh ‘897 patent does not even mention sheets or laminate structures, and relies on a high porosity to “vent” volatile pyrolysis byproduct gases from the continuous phase during its pyrolysis (e.g., the 13.8% porosity described by such patent). It would logically be assumed that any extended area sheets of vitreous carbon lacking such high porosity would generate internal pressures from generation of volatiles that would in turn delaminate the respective sheets, and result in failure to produce any useful ultimate product articles.

Surprisingly and unexpectedly, however, it has been found that by using micromorphologically crack-free sheets of vitreous carbon of thickness not exceeding 4 mm, or in other embodiments not exceeding 6 mm, with thin films of interposed catalyzed resin that are cured and subsequently pyrolyzed, it is possible to achieve laminate vitreous carbon structures with thicknesses exceeding 5 mm in the case of micromorphologically crack-free sheets of vitreous carbon of thickness not exceeding 4 mm, and thicknesses exceeding 7 mm in the case of micromorphologically crack-free sheets of vitreous carbon of thickness not exceeding 6 mm, that are likewise micromorphologically crack-free in character.

In a particularly preferred technique for forming such micromorphologically crack-free laminates, two sheets of micromorphologically crack-free sheets of vitreous carbon of thickness not exceeding 4 mm, and in other embodiments not exceeding 6 mm, can be bonded together by the catalyzed resin film, which then is cured and pyrolyzed, to form a three-layer laminate of the two “starting sheets” of vitreous carbon, and an intermediate layer of vitreous carbon deriving from the catalyzed resin film. Such three-layer laminate can then be assembled with an additional vitreous carbon sheet at each of its exterior faces, bonded thereto by a film of catalyzed resin, which then can be cured and pyrolyzed, to form a 7-layer laminate, with such addition of additional sheets at respective faces of the stack being continued to ultimately provide a desired thickness, as a micromorphologically crack-free vitreous carbon article of extended area, e.g., with each of its length and width dimensions being greater than 10 mm, and thickness greater than 5 mm in the case of micromorphologically crack-free starting sheets of vitreous carbon of thickness not exceeding 4 mm, and thicknesses exceeding 7 mm in the case of micromorphologically crack-free starting sheets of vitreous carbon of thickness not exceeding 6 mm.

The aforementioned starting sheets of vitreous carbon having length and width dimensions each greater than 10 mm and thicknesses not exceeding 4 mm, and in other embodiments not exceeding 6 mm, are commercially available, e.g., in micromorphologically crack-free sheets ranging in thickness from 1 mm to 4 mm, and in some instances from 1 mm to 6 mm. Useful sheets for such purpose include the vitreous carbon sheets commercially available from: Structure Probe, Inc. (West Chester, Pennsylvania, USA); Thermo Fisher Scientific (Waltham, Massachusetts, USA) under the trademark ALFA AESER; American Elements (Los Angeles, California, USA); and MilliporeSigma (St. Louis, Missouri, USA), among others. Such micromorphologically crack-free vitreous carbon sheets may for example be formed by various techniques, such as crystallization, solid-state, and ultrahigh purification processes such as sublimation.

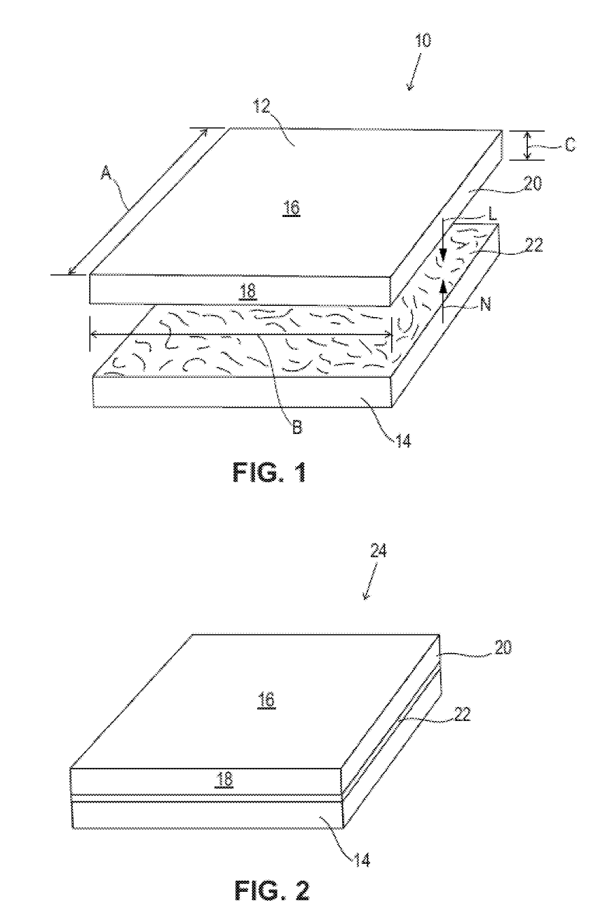

Referring now to the drawings, FIG. 1 is a schematic representation of a three-layer assembly 10, including two sheets 12 and 14 of micromorphologically crack-free vitreous carbon with a layer 22 of catalyzed resin film on the top face of the lower vitreous carbon sheet 14, prior to mating engagement of the vitreous carbon sheets 12, 14 with one another with the layer 22 of catalyzed resin film therebetween.

As illustrated, the top sheet 12 of vitreous carbon has a length A, a width B, and a thickness C, wherein each of A and B is greater than 10 mm, and wherein C in various embodiments is < 4 millimeters, or in other embodiments is < 6 millimeters. The top sheet has an upper face 16, a front face 18, and a side face 20, with the back face corresponding in character to the front face, and a left-hand side face corresponding in character to the right-hand side face 20, with a bottom face corresponding in character to the upper face 16.

The bottom sheet 14 of vitreous carbon likewise has a length and width, each of which is greater than 10 mm, and a thickness that in various embodiments does not exceed 4 mm, and in other embodiments does not exceed 6 mm, with the sheets 12 and 14 being of corresponding dimensions in relation to one another. The top face of bottom sheet 14 has a layer 22 of catalyzed resin film thereon so that when the two sheets 12 and 14 are matably engaged with one another, by downward translation of top sheet 12 in the direction indicated by arrow L and/or upward translation of bottom sheet 14 in the direction indicated by arrow N, the respective sheets 12, 14 are each in contact with the layer 22 of catalyzed resin film therebetween.

FIG. 2 is a schematic representation of the three-layer assembly of FIG. 1, after mating engagement of the vitreous carbon sheets with one another with the layer of catalyzed resin film therebetween, to form the vitreous carbon laminate 24.

The vitreous carbon laminate 24 once formed is subjected to conditions effective for curing of the layer 22 of catalyzed resin film. The catalyzed resin utilized to form the catalyzed resin film layer 22 may be of any suitable type, and may for example comprise furfuryl alcohol that is catalyzed with suitable catalyst, e.g., a Lewis acid, e.g., H⁺, K⁺, Mg²⁺, Fe³⁺, BF₃, CO₂, SO₃, RMgX, AlCl₃, Br₂, etc. The catalyst may be a fast catalyst such as sulfonic acid, maleic acid, or maleic anhydride, which is effective at room temperature. Other catalysts effect polymerization of the furfuryl alcohol at elevated temperatures, including zinc chloride, ferric chloride, ammonium chloride, magnesium chloride, and ammonium sulfate. As a specific example, zinc chloride effectuates polymerization of the furfuryl alcohol rapidly at temperatures on the order of 90°C-100°C. The catalyst in various embodiments may be a mixture of fast ambient temperature catalyst and elevated temperature catalyst, so that the polymerization of furfuryl alcohol to poly(furfuryl alcohol) is carried out at ambient conditions with a rapid “set”, followed by exposure to elevated temperature conditions effective for the catalytic action of the elevated temperature catalyst to achieve a desired completion of the polymerization.

Conditions suitable for polymerization (curing) of the layer of catalyzed resin film may include ambient and/or elevated temperature conditions, depending on the character of the catalyst, and may include pressure conditions of varying character, including ambient pressure, superatmospheric pressure, or subatmospheric pressure, as necessary or desirable in a given application of the process of the present disclosure. The polymerization conditions may further include exposure to curingly effective radiation that is transmissible to the layer of catalyzed resin film, e.g., ultraviolet (UV) radiation, infrared (IR) radiation, microwave radiation, electron beam radiation, or any other radiation that is effective to cure the resin film as a bonding medium for the micromorphologically crack-free vitreous carbon sheets between which the resin film is interposed.

In various embodiments of the present disclosure, the curable resin film between the micromorphologically crack-free vitreous carbon sheets may not require a catalyst, and may be curable by heat and/or radiation exposure alone.

Inasmuch as the curing of the curable resin film may generate volatile reaction by-products, such as water vapor in the curing polymerization of furfuryl alcohol resin to form poly(furfuryl alcohol), it may be desirable to consolidate the micromorphologically crack-free vitreous carbon sheets and curable resin film therebetween under mechanical bearing pressure on an outer face or faces of the respective vitreous carbon sheets in order to prevent the volatile reaction by-products from the curing operation from effecting separation or delamination of the vitreous carbon sheets or vitreous carbon laminates during the curing operation. It may further be desirable to conduct the curing of the curable resin film between the respective micromorphologically crack-free vitreous carbon sheets, under subatmospheric pressure or vacuum conditions, e.g., in a reactor that is evacuated by suitable vacuum pump apparatus. In some embodiments, it may be advantageous to conduct the curing under ultrahigh vacuum conditions, and for such purpose to employee vacuum pumps for effecting such conditions, optionally with use of chemisorbent material(s) to irreversibly chemically react with the curing process volatile by-products, and thereby enhance the efficiency of the curing process.

Accordingly, the curing of the bonding medium between the micromorphologically crack-free vitreous carbon sheets may be carried out with the “stack” of vitreous carbon sheets and interposed bonding medium film between adjacent vitreous carbon sheets being consolidated under mechanical pressure, heat, and/or gas (vapor) pressure conditions as necessary or desirable in a given implementation of the process of the present disclosure.

In general, the thickness of the film of bonding medium between the adjacent vitreous carbon sheets may be any suitable thickness of such bonding medium that is effective to bond the adjacent vitreous carbon sheets to one another over the full areal extent of their respective faces that are in face surface registration with one another. In various embodiments, the thickness of the bonding medium film may be from 0.01 mm to 0.5 mm or more, more preferably from 0.03 mm to 0.3 mm or more, or in other thickness range or particular values, as appropriate to the specific application. In other embodiments, the bonding medium film thickness may be in a range of from 0.05 mm to one millimeter or more, or in a range in which the endpoints are selected from among 0.05 mm, 0.10 mm, 0.15 mm, 0.20 mm, 0.25 mm, 0.30 mm, 0.35 mm, 0.40 mm, 0.45 mm, 0.50 mm, 0.55 mm, 0.60 mm, 0.65 mm, 0.70 mm, 0.75 mm, 0.80 mm, 0.85 mm, 0.90 mm, 0.95 millimeter, and 1.0 mm, wherein the lower end point is of lesser numeric value than the upper end point. The film of curable bonding medium may be applied in any suitable manner, including, without limitation, brushing, spraying, roller coating, dip coating, vapor deposition, or other suitable method or technique.

The curing conditions in the curing of the resin film between vitreous carbon sheets, between vitreous carbon laminates, and/or between a vitreous carbon sheet and a vitreous carbon laminate, with modulation of process conditions under the control of a central processor unit (CPU), including modulation of temperature with time, modulation of gas (vapor) pressure with time, and/or modulation of any other conditions effective to produce curing of the cured resin between vitreous carbon sheets, between vitreous carbon laminates, and/or between a vitreous carbon sheet and a vitreous carbon laminate. The curing may be conducted with the vitreous carbon sheets and/or laminates subjected to mechanical pressure at an outer face or faces thereof, so that curing and consolidation are carried out without separation or delamination occurring.

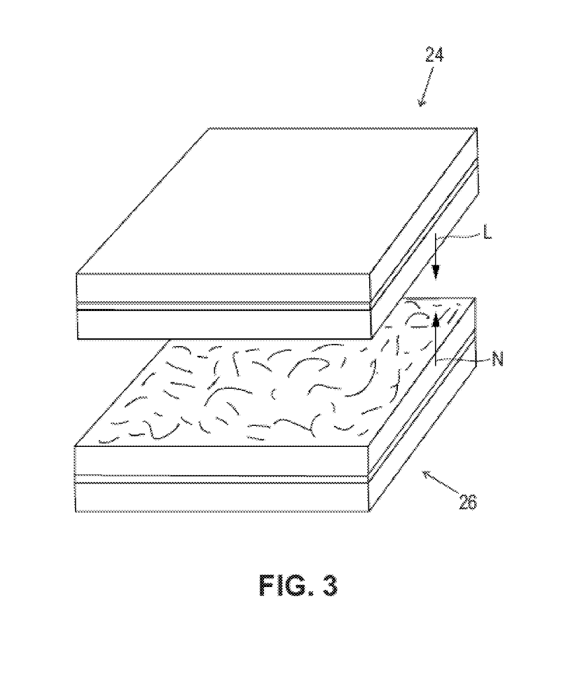

FIG. 3 is a schematic representation of a six-layer composite assembly of two three-layer vitreous carbon laminates 24 and 26, each constituted as shown in FIG. 2, with a layer of catalyzed resin film on the top face of the lower three-layer vitreous carbon laminate, prior to mating engagement of the respective three-layer vitreous carbon laminates with one another with the layer of catalyzed resin film therebetween. The mating engagement of the respective vitreous carbon laminates 24 and 26 with one another is effected by downward translation of top laminate 24 in the direction indicated by arrow L and/or upward translation of bottom laminate 26 in the direction indicated by arrow N, so that the respective laminates 24 and 26 are each in contact with the layer 22 of catalyzed resin film therebetween.

It will be appreciated that the process illustratively described in connection with FIGS. 1-3 above may be progressively carried out so that a number of component stacks of laminates are produced and the respective laminates assembled and bonded to one another, in an appropriate fashion, or in which a laminate stack is formed and vitreous carbon sheets are added thereto in a sequential manner.

Once the curing of the resin has been completed, the cured resin between adjacent vitreous carbon sheets may be pyrolyzed. This may be done in any suitable manner. For example, a three-layer laminate comprising two vitreous carbon sheets and a cured resin layer therebetween may be subjected to conditions to pyrolyze the cured resin to constitute a vitreous carbon laminate, following which the vitreous carbon laminate comprising a vitreous carbon interlayer of the pyrolyzed resin between the originally provided vitreous carbon sheets may thereupon be bonded to a second vitreous carbon laminate comprising a vitreous carbon interlayer of the pyrolyzed resin between originally provided vitreous carbon sheets, by applying a layer of the curable resin to one of the faces of one of the laminates, followed by bringing the resin-bearing face of the first laminate into contact with a face of the second laminate, and consolidating the two laminates with one another by curing and subsequently pyrolyzing the resin. In this manner, laminate subassembly blocks can be formed that are then consolidated with other laminate subassembly blocks to form a product vitreous carbon laminate of desired thickness.

Pyrolysis of the cured resin (bonding medium) may be carried out as part of a continuous process operation, with pyrolysis being initiated immediately following curing, such as in a same reactor adapted to provide the required curing and pyrolysis conditions, or laminates with previously cured resin interlayers may be subsequently subjected to pyrolysis conditions, in temporally separated curing and pyrolysis processes. For the purposes of high-volume manufacturing, a series arrangement of curing and pyrolysis vessels may be employed, with a curable resin application process being conducted upstream of the resin curing vessel, so that the vitreous carbon sheets and/or vitreous carbon laminates undergo resin application, curing, and pyrolysis in separate stages of the process system.

The pyrolysis conditions may be provided by modulation of process conditions under the control of a central processor unit (CPU), including modulation of temperature with time, modulation of gas (vapor) pressure with time, and/or modulation of any other conditions effective to produce pyrolysis of the cured resin between vitreous carbon sheets, between vitreous carbon laminates, and/or between a vitreous carbon sheet and a vitreous carbon laminate. The pyrolysis may be conducted with the vitreous carbon sheets and or laminates subjected to mechanical pressure at an outer face thereof, so that pyrolysis and consolidation are carried out without separation or delamination occurring.

The pyrolysis operation thus may include pressure conditions of varying character, including ambient pressure, superatmospheric pressure, or subatmospheric pressure, as necessary or desirable in the given implementation. The pyrolysis conditions may further include exposure to radiation, e.g., ultraviolet (UV) radiation, infrared (IR) radiation, microwave radiation, electron beam radiation, or other radiation.

The processing of the vitreous carbon sheets and vitreous carbon laminates in respective curing and pyrolysis operations may include the use of a variable frequency microwave generator or oven, whose frequency is modulated to effect the curing and pyrolysis of the resin interlayer, or a series arrangement of variable frequency microwave ovens in which an upstream oven or chamber is employed for curing and a downstream oven or chamber is used for pyrolysis, for batch, semi-batch, or continuous manufacturing of product vitreous carbon laminates.

The curing of the applied resin and the pyrolysis of the cured resin may be carried out with the same or different modalities of heating, including any one or more of conductive, convective, and radiative heating of the resin, and the use of same or different heating apparatus, or combinations of heating apparatus. Heating apparatus may be provided for radiative heating of the resin by any suitable electromagnetic radiation, including infrared radiation, microwave radiation, ultraviolet radiation, or radiation in other portions of the electromagnetic spectrum to which the resin is responsive for heating to carry out the curing and/or pyrolysis of the resin. Electron beam devices may also be employed, as for example in a rastering assembly or print head assembly in 3D printing of vitreous carbon material, as hereinafter more fully described.

In implementations of the present disclosure in which microwave radiation is employed, such radiation can be used to effect or promote curing of resin between vitreous carbon sheets, or resin between a vitreous carbon sheet and a previously formed vitreous carbon laminate, or resin between previously formed vitreous carbon laminates. Polymerization of the resin thus can be mediated by the microwave radiation, as well as pyrolysis of the cured resin, and microwave radiation may therefore be employed in the course of any cured or curing state, from the beginning of curing to the completion of resin pyrolysis, and processing of the resin may be carried out using a hybrid system that includes microwave radiation generation together with other heating system(s) during the entire processing cycle, or any part or portion thereof. Microwave curing may be particularly beneficial in various applications for achieving longer and more efficient cross-linking of cross-linkable resins.

It will be recognized that in the context of the foregoing considerations, the resin chemistry may be selected or modified for responsivity to microwave radiation or other heating modalities, and the chemical synthesis or conversion of the resin may be improved or optimized by modifying the initial chemistry selection for such purpose. More generally, selection of additives and/or modifications to the resin may be utilized to achieve a desired synthesis conversion and efficiency in the production of the vitreous carbon laminate articles of the present disclosure.

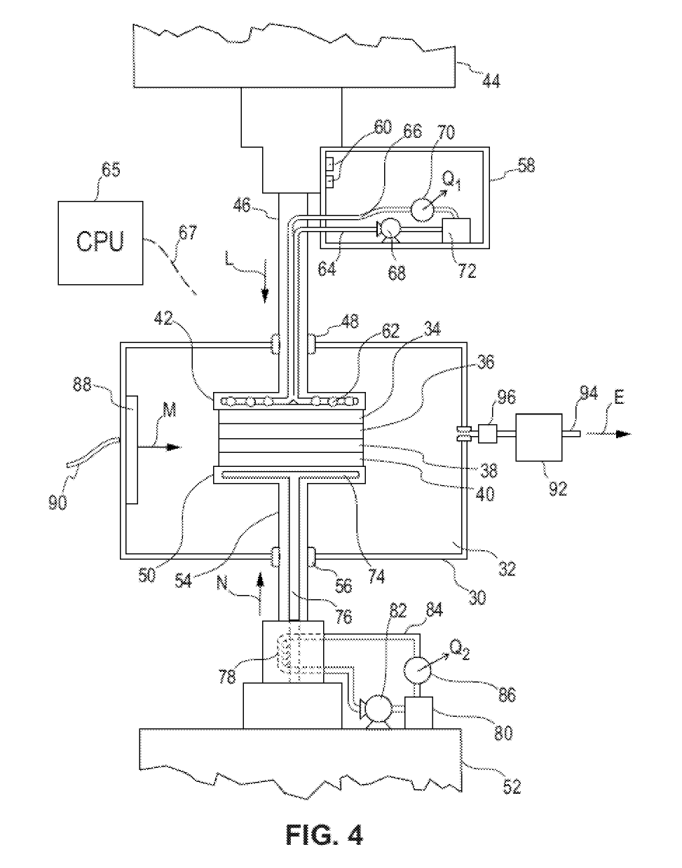

FIG. 4 is a schematic representation of an apparatus for forming vitreous carbon laminates of the present disclosure, according to another aspect thereof.

The apparatus illustrated in FIG. 4 includes a reactor vessel 30 defining an interior volume 32 in which a stack of vitreous carbon sheets and/or laminate articles 34, 36, 38, and 40 are disposed between hydraulic press bearing plates 42 and 54 processing.

The hydraulic press bearing plate 42 is associated with a hydraulic press drive assembly 44, which includes a hydraulic press drive shaft 46 that may be bidirectionally driven, either upwardly or downwardly as required, but which in FIG. 4 is shown as having been driven downwardly in the direction indicated by arrow L to exert pressure on the stack of vitreous carbon sheets and/or laminate articles 34, 36, 38, and 40 during the processing of such sheets and/or articles. The hydraulic press drive shaft 46 is sealed at its passage into the interior volume 32 of the reactor vessel, by hydraulic press drive shaft seal 48.

The hydraulic press bearing plate 50 is associated with a hydraulic press drive assembly 52, which includes a hydraulic press drive shaft 54 that may be bidirectionally driven, either upwardly or downwardly as required, but which in FIG. 4 is shown as having been driven upwardly in the direction indicated by arrow N to exert pressure on the stack of vitreous carbon sheets and/or laminate articles 34, 36, 38, and 40 during the processing of such sheets and/or articles. The hydraulic press drive shaft 54 is sealed at its passage into the interior volume 32 of the reactor vessel, by hydraulic press drive shaft seal 56.

The upper hydraulic press drive assembly 44 is associated with a coolant assembly housing 58 that is bolted to the hydraulic press drive assembly by housing mounting bolts 60. The coolant is simply housing services a coolant manifold 62 in the hydraulic press bearing plate 42, with coolant being circulated through the passages of the coolant manifold 62 from a coolant reservoir 72 that is coupled with coolant flow circuitry including a coolant feed line 64 and a coolant return line 66, the return line containing a chiller 70 for removal of heat (denoted by heat flux Q₁) from the coolant, and the feed line 64 containing a pump 68 for maintaining circulation of coolant through the flow circuitry.

The upper hydraulic press drive assembly 40 for is associated with a heat pipe cooling structure for the hydraulic press bearing plate 50, which contains a heat pipe bearing plate channel 74 therein. The heat pipe bearing plate channel 74 is in fluid flow communication with the heat pipe tubular passage 76 in the hydraulic press drive shaft 54, and the lower extremity of the heat pipe tubular passage 76 is in heat exchange relationship with heat exchange coil 78 in the hydraulic press drive assembly. The heat exchange coil 78 is coupled with a coolant circulation line 84, joining the heat exchange coil to coolant reservoir 80 providing coolant that is flowed to the heat exchange coil 78 and through the coolant circulation line 84 by pump 82. The coolant circulation line 84 contains in the return line portion of the coolant circulation line a coolant chiller 86 for removal of heat (denoted by heat flux Q₂) from the coolant as it is returned to the coolant reservoir, from which it is circulated by action of the pump 82 to the heat exchange coil 78.

By the provision of the respective coolant arrangements, the respective hydraulic press bearing plates 42 and 50 provide extended area heat exchange surface for removal of heat from the stack of vitreous carbon sheets and/or laminate articles 34, 36, 38, and 40 during the processing of such sheets and/or articles. It will be appreciated that the specific coolant arrangements shown may be varied in the implementation of the processing apparatus, and the coolant arrangement shown in connection with the upper hydraulic press bearing plate 42 may also be utilized for cooling of the lower hydraulic press bearing plate 50, and that alternatively, the coolant arrangement shown in connection with the lower hydraulic press bearing plate 50 may also be utilized for cooling of the upper hydraulic press bearing plate 42. It will be further appreciated that any other cooling or heat removal techniques and devices may be employed to thermally modulate temperature in the stack of vitreous carbon sheets and/or laminate articles 34, 36, 38, and 40 during processing thereof.

Although respective cooling arrangements have been shown in connection with the upper hydraulic press bearing plate and lower hydraulic press bearing plate, it will likewise be appreciated that the respective arrangements may be adapted to provide heating of the stack of vitreous carbon sheets and/or laminate articles 34, 36, 38, and 40 during the processing of such sheets and/or articles, by providing heaters rather than chillers in the respective flow circuits.

Further, heat exchangers may be employed in the respective flow circuits to provide fluid heating as well as cooling capability in such flow circuits, to modulate temperature in the stack of vitreous carbon sheets and/or laminate articles 34, 36, 38, and 40 during the processing of such sheets and/or articles, by heating or cooling as needed during the processing of the stack of vitreous carbon sheets and/or laminate articles. Thus, the flow circuits may be employed to cool the stack during polymerization of the catalyzed resin, to dissipate the heat and control the time-temperature relationship in the polymerization operation, and the flow circuits may be employed to heat the stack in the pyrolysis operation after the polymerization has been completed. Thus, the final product laminate may be consolidated under mechanical pressure and heating of the previously polymerized resin bonding medium.

The reactor vessel 30 is also shown in FIG. 4 as having a variable frequency microwave generator 88 mounted on a sidewall thereof, as electrically powered by the microwave generator power line 90 connected to the variable frequency microwave generator.

The variable frequency microwave generator can thus be employed to impinge microwave radiation M on the stack mounted in the reactor vessel during the polymerization and/or pyrolysis operations, with the microwave generator being controllably operated at variable frequency to provide a correspondingly selected microwave radiation intensity for such heating. The variable frequency microwave generator may be joined via signal transmission wires to a processor or controller (CPU) for modulating the microwave generator to provide microwave heating of the resin material according to a predetermined time-temperature schedule to effect polymerization and/or subsequent pyrolysis of the resin material.

The reactor vessel 30 also is shown in FIG. 4 as having a vacuum pump discharge line 94 communicating through the wall of the reactor vessel with the interior volume 32 of the vessel, to exhaust gas from the interior volume as effluent denoted by arrow E, by action of the vacuum pump 92 in such discharge line. The discharge line may further optionally include a chemisorbent canister 96 upstream of the vacuum pump, to remove reaction product gas species that are desirably minimized in the gas flow to the vacuum pump. The vacuum pump may correspondingly be actuated during processing of the stack in the reactor to remove evolved gases from the stack and ensure that the stack is fully microcrack-free in character at the conclusion of processing.

It will be recognized that the processing apparatus shown in FIG. 4 is of an illustrative character only, and that the structure, components, and operation of the processing apparatus may be widely varied in the general practice of the present disclosure, to produce vitreous carbon laminates of a desired character.

Further, although the vitreous carbon sheets and laminates have been shown as being of a rectangular geometry, it will be recognized that the specific shape of the sheets and laminates may be varied in the practice of the present disclosure.

The apparatus shown in FIG. 4 illustratively includes a central processor unit (CPU) 65 that is schematically depicted with a signal transmission line 67 that may bidirectionally carry signals to and from the CPU 65, with the CPU thereby linked with any one or components in the apparatus, via as many signal transmission lines as are necessary therefor, with the linked components including any of the apparatus components shown, e.g., pumps, chillers, microwave generator, hydraulic press elements, or additional temperature sensing elements, pressure sensing elements, flow controllers, humidity monitors, or any other components, assemblies, or elements of the apparatus system.

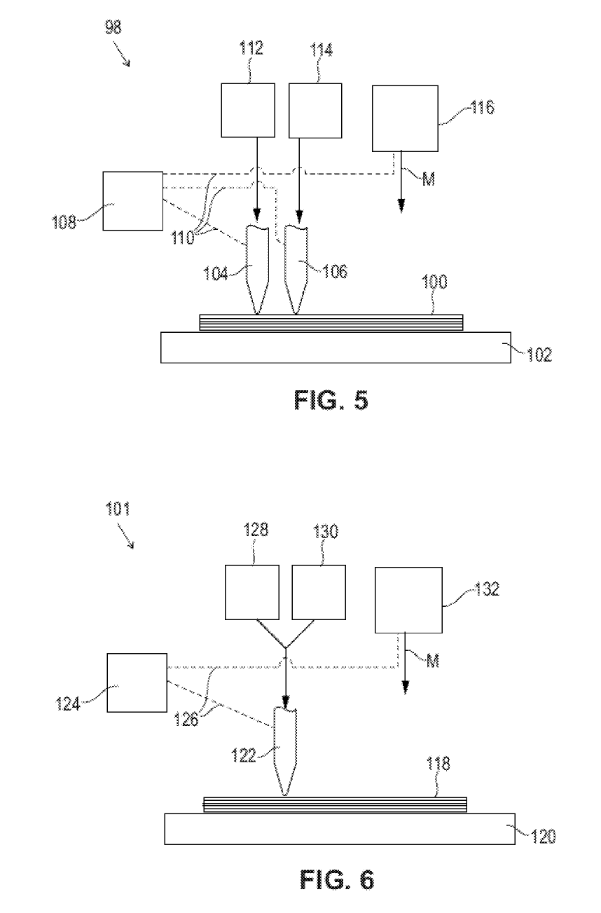

FIG. 5 is a schematic representation of an apparatus 98 for 3D printing of vitreous carbon articles, in accordance with a further aspect of the invention.

The 3D printing apparatus 98 may be employed to form a 3D printed vitreous carbon article 100 on the 3D printer platform 102, by supply of a curable and pyrolyzable resin from a resin reservoir 112 to a first print head 104 that is translated in the x-y plane and incrementally adjusted in the z-direction in the course of printing. The print head 104 is translationally controlled by the central processor unit (CPU) 108, with the CPU being joined in signal transmission relationship with the print head 104 by a CPU signal transmission line 110, shown in dashed line representation in FIG. 4. Concurrently with the printing of resin from the first print head 104, responding to control signals transmitted from the CPU to such print head, catalyst is supplied from catalyst reservoir 114 to the second print head 106, which likewise is controllably translated by the CPU 108, via the signal transmission line 110 interconnecting the CPU and print head 106, and in trailing relationship to the print head 104, print head 106 prints catalyst on the resin printed by print head 104. The 3D printing system 98 in the embodiment shown in FIG. 4 includes a variable frequency microwave generator 116, arranged to impinge microwave radiation M on the 3D printed article at variable microwave intensity, to effect polymerization and subsequently pyrolysis of the printed material. For such purpose, the variable frequency microwave generator 116 may be coupled with the CPU 108 by signal transmission line 110 as illustrated, so that the microwave radiation is controllably delivered to the 3D printed material during the respective polymerization and pyrolysis processes.

In other embodiments, instead of a variable frequency microwave generator, a heating assembly may be employed for performing the curing and pyrolysis operations under elevated temperature conditions. The 3D printing apparatus 98 in various embodiments may comprise a chamber in which the 3D printing is performed by the apparatus components schematically shown in FIG. 5. The chamber in like manner to the reactor vessel in FIG. 4 may be coupled with a vacuum pump communicating with the interior volume of the chamber and operative to maintain subatmospheric pressure conditions in the 3D printing operation.

FIG. 6 is a schematic representation of an apparatus 101 for 3D printing of vitreous carbon articles, in accordance with another aspect of the invention. In the FIG. 63D printing apparatus, a resin reservoir 128 and catalyst reservoir 130 are arranged to dispense resin and catalyst to form a mixture in the delivery line to print head 122 for printing of the resin and catalyst mixture to form a vitreous carbon article 118 on the 3D printer platform 120, with the print head 122 being translated in the x-y plane and incrementally adjusted in the z-direction in the course of printing.

CPU 124 is shown as being coupled in signal transmission relationship with print head 122 by the CPU signal transmission line 126, to controllably translate the print head as required. A variable frequency microwave generator 132 is employed in such system, as arranged to impinge microwave radiation M on the 3D printed article at variable microwave intensity, to effect polymerization and subsequently pyrolysis of the printed material. For such purpose, the variable frequency microwave generator 132 may be coupled with the CPU 124 via signal transmission line 126, so that the microwave radiation is controllably delivered to the 3D printed material during the respective polymerization and pyrolysis processes.

It will be recognized that other radiation or heating sources may be employed in the 3D printing system instead of the variable frequency microwave generator, and that other arrangements of the variable frequency microwave generator may be employed. For example, a 3D printing system may be employed in which the print head is in an assembly that also includes, in trailing relationship to the print head, an electron beam delivery device, so that upon printing of the resin or the resin and catalyst mixture, the printed resin or resin and catalyst mixture is subsequently but contemporaneously irradiated with the electron beam to effect curing of the resin, or curing and pyrolysis, such as by a print head assembly that includes, in addition to the print head, a first electron beam delivery device, in trailing relationship to the print head, for effecting curing of the resin, and a second electron beam delivery device, in trailing relationship to the first electron beam delivery device, for effecting pyrolysis of the cured resin. In this manner, fully pyrolyzed lines are progressively added to the 3D printed article, under controlled temperature conditions that may be modulated according to a predetermined temperature-time schedule in order to manufacture the product vitreous carbon article of desired size, shape, and thickness characteristics.

As in the 3D printing apparatus shown in FIG. 5, the 3D printing apparatus shown in FIG. 6 may utilize, instead of a variable frequency microwave generator, a heating assembly for performing the curing and pyrolysis operations under elevated temperature conditions. The 3D printing apparatus 101 in various embodiments may also comprise a chamber in which the 3D printing is performed by the apparatus components schematically shown in FIG. 6. The chamber in like manner to the reactor vessel in FIG. 4 may be coupled with a vacuum pump communicating with the interior volume of the chamber and operative to maintain subatmospheric pressure conditions in the 3D printing operation.

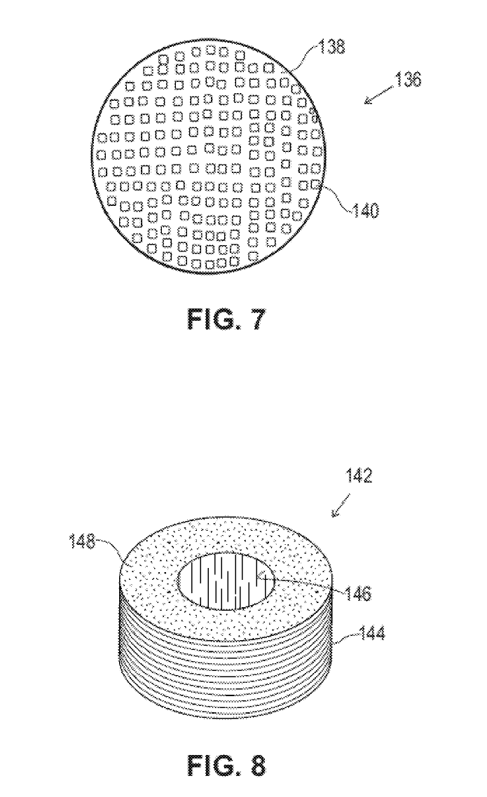

FIG. 7 is a top plan view of a channelized vitreous carbon article 136, e.g., a bearing element for use in a roller bearing assembly, or other bearing application, formed by 3D printing, in accordance with an additional aspect of the disclosure.

The channelized vitreous carbon article 136 comprises a 3D printed body 138 containing 3D print-defined channels 140 therein. Such vitreous carbon article can be formed for example by printing of curable and pyrolyzable resin strands including x-axis strands and y-axis strands to form a “screen” conformation defining interstices between the respective parallelly aligned strands and the cross-strands orthogonal thereto. These interstices, or channels, thereafter provide an open matrix in which the channels allow egress of volatile gas products of the curing and pyrolysis reactions, so that no internal or delaminating stresses are produced in the material as a result of the generation of such volatile gas products.

Accordingly, in the 3D printing operation, the successively printed layers of the article may be printed so that the interstices between the resin strand elements are in register with one another, i.e., they constitute through-holes in the resulting cured resin article or subsequent vitreous carbon pyrolyzate, or alternatively, the successively printed layers of the article may be printed so that such interstices are offset with respect to one another but still in communication with the interstices in the immediately preceding and subsequently following layers of the printed article, so as to impart tortuosity to the interstitial passages that are formed.

In this fashion, the 3D printed article may be formed by 3D printing, utilizing 3D printing equipment of suitable type such as the printing systems schematically shown in FIGS. 5 and 6, and the 3D printing can be carried out with curing radiation exposure at the time of the printing of the material, or subsequently, or the curing may be carried out by subjecting the 3D printed material to elevated temperature conditions at the time of 3D printing or subsequently, after the 3D printed article is formed, and the cured resin article then may be subjected to pyrolysis conditions that are effective to form the vitreous carbon product article.

Such 3D printing of channelized vitreous carbon precursor articles thus addresses the thickness issue and allows the curing and subsequent pyrolysis of the printed material and printed article to take place without the formation of microcracks, so that the resulting article is microcrack-free in character.

The 3D printing may be carried out in a wide variety of patterns to create channelized 3D printed structures.

For example, FIG. 8 is a schematic perspective view of a vitreous carbon compressor shaft seal ring 142 according to a further embodiment of the disclosure, including a cylindrical body 144 defining an interior surface bounding a cylindrical opening through which the seal ring is engaged with a rotary or reciprocating shaft of a compressor apparatus, wherein the cylindrical body has been 3D printed to form 3D print-defined pores 148, as channels in the vitreous carbon article that in prior processing allows the free evolution of gases from the corresponding precursor article during the respective curing and pyrolysis steps. This enables the manufacturing of seal ring or other vitreous carbon articles having substantial thickness, e.g., of 2-10 cm or more, and which are microcrack-free in character.

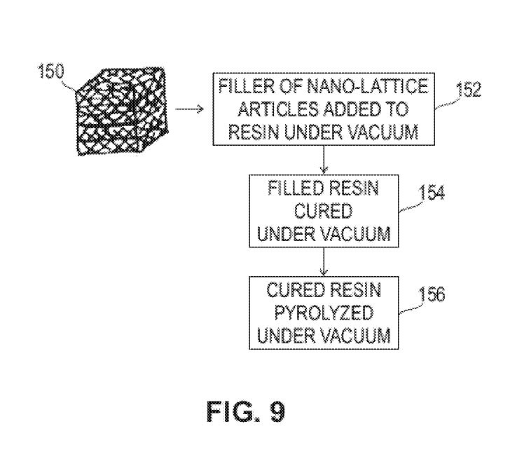

FIG. 9 is a schematic depiction of a nanolattice filler article 150, and steps involved in forming a vitreous carbon composition according to a further aspect of the invention.

The nanolattice filler article 150 is of a type recently reported in Crook, C. et al, Plate-nanolattices at the theoretical limit of stiffness and strength, Nature Communications, 2020, 11:1579, https://doi.org/10.1038/s 41467-020-15434-2, www.nature.com/naturecommunications (accessed May 1, 2020, and the disclosure of which is hereby incorporated herein by reference). Crook et al. describe the formation of defect-free pyrolyzed carbon nanolattices constructed from closed-cell plate-architectures, by fabrication including two-photon lithography and pyrolysis, according to the technique disclosed therein, to yield pyrolyzed carbon nanolattice cubic articles having holes of diameter 100-160 nm at the center of the plate faces thereof. These vitreous carbon nanolattice cubic articles have substantial internal void volumes and dimensions that may for example be on the order of 5 µm on a side (i.e., 5 µm x 5 µm x 5 µm).

In accordance with a further aspect of the present disclosure, the vitreous carbon nanolattice cubic articles are utilized as filler in the precursor resin that is cured and subsequently pyrolyzed to form a vitreous carbon article. Since they are of vitreous carbon structure, they introduce no coefficient of thermal expansion issues or chemical compatibility issues, and since they are of high strength and stiffness, they impart a high degree of strengthening of the vitreous carbon material containing same.

FIG. 9 schematically depicts a single vitreous carbon nanolattice cubic article, as representative of the multiplicity of such articles constituting the filler, which in step 152 are added to the precursor resin for the final vitreous carbon article under vacuum. The imposition and maintenance of vacuum in this step is important, since the cubic articles contain void space and under vacuum conditions are evacuated. Thus, the nanolattice cubic articles in this step will be evacuated, but the small facial opening dimensions of such articles, and attendant surface tension effects, will prevent ingress of the precursor resin into the interior volume of the nanolattice cubic articles.

Next, in step 154, the resin containing the nanolattice cubic articles as filler is cured under the vacuum conditions. The filler content of the nanolattice cubic articles in the resin is selected so that gases generated during the curing operation will enter the evacuated interior voids in the nanolattice cubic articles, which thereby serve to hold and contain such gases, so that such evolved gases do not cause void formation, fissures, and microcracking in the final vitreous carbon composition. Such action of evolved gases take up by the nanolattice cubic articles then continues in step 156, in which the cured resin is pyrolyzed under vacuum conditions, and the byproduct gases from the pyrolysis likewise enter and are subsequently contained in the nanolattice cubic articles.

By such processing, vitreous carbon compositions can be formed, containing the evolved gas–receiving nanolattice cubic articles as filler therein, wherein the vitreous carbon composition is microcrack-free in character, but due to the presence of the nanolattice cubic articles therein is of a high strength of character, and the contained gas in the nanolattice cubic articles serves to reduce the overall density of the vitreous carbon composition so that it is substantially stronger yet lighter than conventional vitreous carbon materials.

It therefore is to be appreciated that the present disclosure affords a variety of approaches to the achievement of high-thickness vitreous carbon compositions and articles, which may be utilized in the production of a wide variety of articles, including, without limitation, pump and compressor seals, brake linings, pantographs for electrical vehicles, space vehicle heat shields, and articles useful in tribological, mechanical, and electrical applications.

_____________

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the claims as hereinafter presented are intended to be broadly construed and interpreted, as including all such variations, modifications and alternative embodiments, within their spirit and scope.

Listing of Reference Numbers
10 three-layer assembly
12 top vitreous carbon sheet
14 bottom vitreous carbon sheet
16 upper face
18 front face
20 side face
22 layer of catalyzed resin film
24 vitreous carbon laminate
26 vitreous carbon laminate
30 reactor vessel
32 interior volume
34 vitreous carbon sheet or laminate
36 vitreous carbon sheet or laminate
38 vitreous carbon sheet or laminate
40 vitreous carbon sheet or laminate
42 hydraulic press bearing plate
44 hydraulic press drive assembly
46 hydraulic press drive shaft
48 hydraulic press drive shaft seal
50 hydraulic press bearing plate
52 hydraulic press drive assembly
54 hydraulic press drive shaft
56 hydraulic press drive shaft seal
58 coolant assembly housing
60 housing mounting bolts
62 coolant manifold
64 coolant feed line
65 central processor unit (CPU)
66 coolant return line
67 signal transmission line
68 pump
70 coolant chiller
72 coolant reservoir
74 heat pipe bearing plate channel
76 heat pipe tubular passage
78 heat exchange coil
80 coolant reservoir
82 pump
84 coolant circulation line
86 coolant chiller
88 variable frequency microwave generator
90 microwave generator power line
92 vacuum pump
94 vacuum pump discharge line
96 chemisorbent canister
98 3D printing system
100 3D printed vitreous carbon article
101 3D printing system
102 3D printer platform
104 print head
106 print head
108 central processor unit (CPU)
110 CPU signal transmission lines
112 resin reservoir
114 catalyst reservoir
116 variable frequency microwave generator
118 3D printed vitreous carbon article
120 3D printer platform
122 print head
124 central processor unit (CPU)
126 CPU signal transmission line
128 resin reservoir
130 catalyst reservoir
132 variable frequency microwave generator
136 bearing article
138 3D printed body
140 channels
142 compressor shaft seal ring
144 cylindrical body
146 inner surface
148 3D print-defined pores
150 nanolattice filter article
152 filler and resin mixing
154 resin composition curing
156 cured resin pyrolysis

What is claimed is:

1. A method of forming a vitreous carbon article, comprising applying a curable and pyrolyzable resin at a thickness of 0.01-0.5 mm on a vitreous carbon body, impinging microwave radiation on the curable and pyrolyzable resin from a variable frequency microwave generator, and modulating the variable frequency microwave generator to vary microwave radiation intensity of the impinging microwave radiation to effect polymerization and subsequent pyrolysis of the curable and pyrolyzable resin to produce vitreous carbon therefrom.

2. The method of claim 1, wherein the method is repeated to progressively add vitreous carbon to the vitreous carbon body, to form the vitreous carbon article with predetermined size and shape characteristics.

3. The method of claim 1, wherein the variable frequency microwave generator is coupled with a central processor or controller so that the microwave radiation is controllably delivered to the resin during the respective polymerization and pyrolysis at effective microwave radiation intensity therefor.

4. The method of claim 3, wherein the processor or controller modulates the variable frequency microwave generator to provide microwave heating of the curable and pyrolyzable resin according to a predetermined time-temperature schedule to effect the polymerization and subsequent pyrolysis.

5. The method of claim 1, wherein the curable and pyrolyzable resin comprises a resin that is curable by cross-linking.

6. The method of claim 1, wherein the curable and pyrolyzable resin comprises furfuryl alcohol.

7. The method of claim 1, wherein the curable and pyrolyzable resin is applied in a resin composition comprising a curing catalyst for the curable and pyrolyzable resin.

8. The method of claim 7, wherein the curing catalyst comprises a Lewis acid.

9. The method of claim 8, wherein the Lewis acid comprises one or more of H⁺ K⁺ Mg²⁺ Fe³⁺ BF₃ CO₂ SO₃ RMgX, AlCl₃ and Br₂.

10. The method of claim 7, wherein the curing catalyst comprises sulfonic acid, maleic acid, or maleic anhydride.

11. The method of claim 7, wherein the curing catalyst comprises zinc chloride, ferric chloride, ammonium chloride, magnesium chloride, or ammonium sulfate.

12. The method of claim 7, wherein the curing catalyst comprises zinc chloride.
